(19) United States
(12) Patent Application Publication
(10) Pub. No.: US 2015/0080057 A1
(43) Pub. Date: Mar. 19, 2015

(54) Sound effects security application for smartphone

(71) Applicant: Rebecca Adams, Farmington, MN (US)

(72) Inventor: Rebecca Adams, Farmington, MN (US)

(21) Appl. No.: 14/486,144

(22) Filed: Sep. 15, 2014

Related U.S. Application Data
(60) Provisional application No. 61/877,285, filed on Sep. 13, 2013.

(51) Int. Cl. H04M 1/725

(52) U.S. Cl. CPC H04M 1/72558; H04M 1/72583
USPC 455/566

(57) ABSTRACT

A sound effects security application for a smartphone provides icons on the visual display that are linked to sound effect audio files simulating a handgun being loaded, a shotgun jacking a fresh shell into the chamber, a barking dog, a piercing alarm and other similarly alarming sounds. The intended result of the sound is to cause intruders to hesitate before continuing to enter the premises.

### CROSS-REFERENCE TO RELATED APPLICATIONS

This application claims the benefit of U.S. Provisional Application No. 61/877,285, filed Sep. 13, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to smartphone applications and in particular to a sound effects security application for a smartphone. The approach of an intruder at home can be very frightening. By creating certain recognizable sounds, a smartphone can be used to turn the tables and frighten away the intruder, or cause the intruder to hesitate long enough for the user to call emergency services, thus leading to a safe resolution of the intrusion. A smartphone application which creates a series of sound effects simulating a handgun being loaded, a shotgun jacking a fresh shell into the chamber, or a barking dog may make the difference in such situations.

### SUMMARY OF THE INVENTION

Accordingly, the invention is directed to a sound effects security application for a smartphone. Icons on the visual display are linked to sound effect audio files simulating a handgun being loaded, a shotgun jacking a fresh shell into the chamber, a barking dog, a piercing alarm and other similarly alarming sounds. The intended result of the sound is to cause intruders to hesitate before continuing to enter the premises.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 shows a front view of a smartphone with the first exemplary embodiment installed, displaying the shotgun icon 10, the pistol icon 11, the barking dog icon 12, the smartphone 13, and the visual display 14.

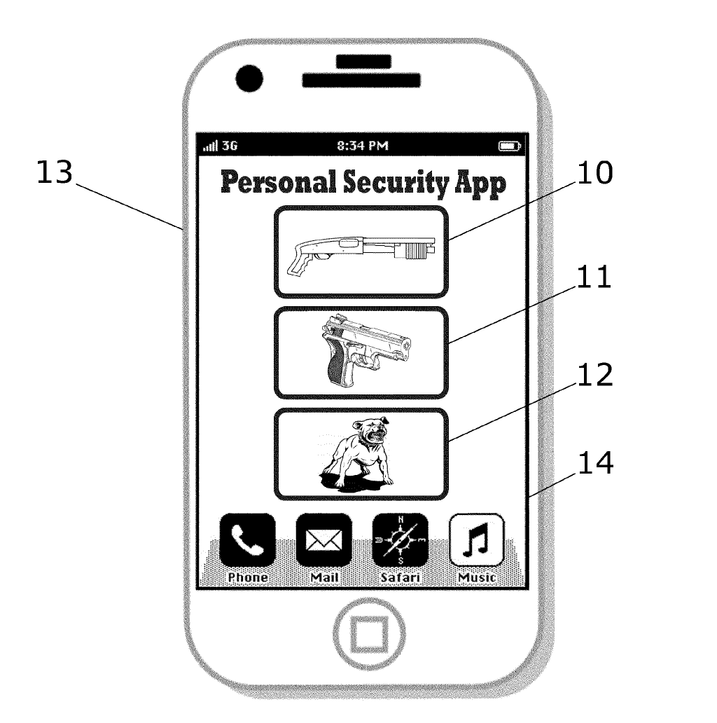

### DETAILED DESCRIPTION OF THE INVENTION

Referring now to the invention in more detail, the invention is directed to a sound effects security application for a smartphone. Icons on the visual display 14 are linked to sound effect audio files, simulating a handgun being loaded, a shotgun jacking a fresh shell into the chamber, or a barking dog. The result of playing back the audio file is to deter or cause hesitation in an intruder into the user's home, assailant to the user's person, or other person intending to cause harm to the user; generically, such a person may be understood as an intruder. The intended result is that the intruder will withdraw in response to the sound or at least hesitate for sufficient time for the user to contact emergency services. Additionally, other recorded sounds whose content is of a generally deterrent nature may be provided.

The smartphone application downloads or comes preloaded with audio files in MP3 format, or any one of several other audio file formats, and stores them on the memory device of the user's smartphone 13. The stored audio files are sound effect files simulating a pistol being loaded, a shotgun jacking a fresh shell into the chamber, a barking dog, a piercing alarm and other similarly alarming sounds. When the application is activated, three large icons are displayed on the visual display 14 of the user's smartphone 13. Each icon on the application controls the corresponding sound for example; the shotgun icon 10 controls the sound effect file which simulates a shotgun jacking a fresh shell into the chamber, the pistol icon 11 controls the sound effect file which simulates a pistol being loaded, the barking dog icon 12 controls the sound effect file which simulates a barking dog. The interface so described is preferably, but not necessarily, implemented as an “app” within the user interface of the smartphone; the terms “app” or “application” as used herein refer generically to any interface wherein the user is presented with icons or selections corresponding to the provided sound effects and permits selectively playing back the desired sound effects.

The app would be configured to ignore standard audio playback settings of the operating device. Specifically, the app would override standard volume control and silence settings and ignore the connection of earphones, headsets, vehicle speaker systems and other output accessories other than the below-described output accessory. The app would attempt to playback sound effects at the maximum volume available for the device hardware, optionally overriding limits that may normally be in place to protect the device hardware or user's hearing. For devices with limited volume output, an external, high power and high output speaker may be provided. The speaker may connect to the operating device via analog signal cable, USB, Bluetooth, or other data transfer medium suitable for carrying sound data.

To use the first exemplary embodiment, the user activates the smartphone application and taps on the icon corresponding to the sound effect which the user chooses to employ.

The application may arrive to the user pre-installed on the smartphone 13 or may be available as an aftermarket download.

The smartphone 13 would preferably be manufactured from durable, rigid materials, such as steel, aluminum, and high impact plastic. The visual display 14 would preferably be manufactured from a rigid, durable, transparent material such as malacrylate. The software method of the invention may equivalently operate other mobile electronic data devices, for example tablets and notebook computers; the term “smartphone” as used herein and in the claims that follow is intended to mean mobile electronic data devices generally.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A software method of operating a smartphone as a personal security device comprising providing a plurality of recorded sounds; the content of said plurality of recorded sounds being of a nature that is deterrent to an intruder; said plurality of recorded sounds being stored in the memory of a smartphone; said plurality of recorded sounds being accessible through an application; said application providing selective playback of said plurality of recorded sounds; and said application being configured to play back said plurality of recorded sounds at the maximum volume possible via the playback hardware of said smartphone; whereby a user may selectively play back any of said plurality of recorded sounds in the presence of said intruder such that said intruder may withdraw or hesitate.

2. The software method of operating a smartphone as a personal security device of claim 1 wherein at least one of said plurality of recorded sounds is selected from the group of a handgun being loaded, a shotgun jacking a shell, or a barking dog.

3. The software method of operating a smartphone as a personal security device of claim 1 further comprising an external speaker; said external speaker being in electronic communication with said smartphone; said application being configured to play back said plurality of recorded sounds via said external speaker; said external speaker having a maximum volume output exceeding that of said smartphone.

4. The software method of operating a smartphone as a personal security device of claim 3 wherein at least one of said plurality of recorded sounds is selected from the group of a handgun being loaded, a shotgun jacking a shell, or a barking dog.

5. The software method of operating a smartphone as a personal security device of claim 1 wherein said application is configured to ignore and override the normal volume limits of said smartphone.

6. The software method of operating a smartphone as a personal security device of claim 2 wherein said application is configured to ignore and override the normal volume limits of said smartphone.

7. The software method of operating a smartphone as a personal security device of claim 3 wherein said application is configured to ignore and override the normal volume limits of said smartphone.

8. The software method of operating a smartphone as a personal security device of claim 4 wherein said application is configured to ignore and override the normal volume limits of said smartphone.
